(19) United States
(12) Patent Application Publication
(10) Pub. No.: US 2006/0222498 A1
(43) Pub. Date: Oct. 5, 2006

(54) Impeller for centrifugal blower

(75) Inventors: Kazuhiro Yoshida, Togane-shi (JP); Junichi Miyamoto, Togane-shi (JP)

Correspondence Address: OSHA LIANG L.L.P., 1221 MCKINNEY STREET, SUITE 2800, HOUSTON, TX, 77010, US

(73) Assignee: Maruyama Mfg. Co., Inc., Tokyo (JP)

(21) Appl. No.: 11/398,479

(22) Filed: Apr. 5, 2006

(30) Foreign Application Priority Data
Apr. 5, 2005 (JP) 2005-108892

(51) Int. Cl. B64C 11/00

(52) U.S. Cl. 416/182

(57) ABSTRACT

An impeller 10 for a centrifugal blower 3 is of a closed type and comprises a first molded part 18 and a second molded part 20. The first part is formed by integrally molding a side plate 14, vanes 16, and a circular base 26 having a smaller area than a central opening 22 formed in the side plate. The second part acts as a main plate 12, having a boss section 24 formed with a recess section 30 into which the circular base is fitted. The impeller can be formed by joining the first and second parts together to form a single body, by fastening both of the circular base and the boss section to the rotating shaft 8 of a drive source 4 in a state where the circular base is fitted into the recess section.

### BACKGROUND OF THE INVENTION

1. Field of the Invention

The present invention relates generally to an impeller for a centrifugal blower, and more particularly, is concerned with a closed-type impeller.

2. Related Background Art

For example, in a powered scattering device which scatters agricultural chemicals in particulate or powdered form, or in a pneumatic ejection type cleaning device, a centrifugal blower is used for generating an air flow. A centrifugal blower has an impeller which is rotated by an internal combustion engine. Some impellers are of a closed type. The closed-type impeller comprises a circular disc-shaped main plate coupled to a rotating shaft of an internal combustion engine, a ring-shaped side plate disposed at an interval from the main plate and coaxially with same, and a plurality of vanes disposed at equally spaced intervals in the circumferential direction between the main plate and the side plate.

However, it is extremely difficult to manufacture such a closed-type impeller as a single-piece, by resin molding or forging, due to the complexity of manufacturing molds or dies required. Therefore, in the prior art, as described in Japanese Patent Publication Nos. 2003-65292, 2005-9376, and 2003-232294, devices are proposed in which an impeller is manufactured in two or three separate parts, and these parts are then joined together by a suitable means.

In the construction described in the Japanese Patent Publication No. 2003-65292, a main plate, vanes and a side plate are manufactured separately, and the main plate is joined to the vanes, and the side plate are joined to the vanes by means of small bolts or screws.

In the construction described in the Japanese Patent Publication No. 2005-9376, a main plate, vanes and a side plate are manufactured separately similarly to the construction described in the Japanese Patent Publication No. 2003-65292, but the main plate and the side plate are joined to the vanes by crimping. More specifically, a plurality of projections are formed on the edges of the vanes on the sides adjacent to the main plate and the side plate, and furthermore, through holes which receive these projections are formed in the main plate and the side plate. The projections are passed through the through holes and the end portions of the projections are deformed, thereby joining the main plate and the side plate to the vanes.

In the construction described in the Japanese Patent Publication No. 2003-232294, the main plate and the vanes are formed as a single-piece, and the edges of the vanes on the side of the side plate are passed into slits formed in the side plate, and are then joined to the side plate by welding.

However, the constructions as described in those Japanese Patent Publications have problems concerning strength. When the centrifugal blower is driven to rotate the impeller at high speed, stress may occur between the main plate and the vanes, and between the side plate and the vanes. In the situation, if the joint portions are formed by crimping, welding, bolting or the like, the stress may be concentrated at the crimped portions, welding portions or bolts. This has made it difficult to raise the strength of the impeller.

Further, as the impeller described in the Japanese Patent Publication No. 2003-65292 is assembled by bolts, the assembling is laborious.

Accordingly, an object of the present invention is to provide an impeller for a centrifugal blower which can be easily manufactured or assembled, and which has high reliability in terms of strength.

### SUMMARY OF THE INVENTION

In order to achieve the aforementioned object, according to the present invention, there is provided an impeller for a centrifugal blower including a main plate adapted to be attached to a rotating shaft of a drive source, a side plate disposed coaxially at a predetermined interval with respect to the main plate, the side plate having a central opening formed therein, and a plurality of vanes disposed at equally spaced intervals in the circumferential direction between the main plate and the side plate, the impeller comprising: a first molded part including the side plate, the vanes and a fitting section, and molded into a single-piece, the fitting section having a smaller area than the central opening of the side plate and provided on the free edges of the vanes on the side opposite to the side plate in a coaxial relation to the side plate; and a second molded part molded into a single-piece, the second molded part constituting the main plate and having a boss section provided in the center thereof, the boss section being adapted to couple with the rotating shaft of the drive source and having a recess section formed therein into which the fitting section is fitted; wherein the first molded part and the second molded part are integrated into a single body by fastening the fitting section to the boss section in a state where the fitting section is fitted into the recess section.

Here, the term “molding” used in the present specification and the claims means formation by using a mold or die, and is not limited to resin molding, such as injection molding, but may also include molding from metal by casting.

According to the present invention, the vanes and the side plate, and the vanes and the fitting section which acts as a portion of the main plate, are integrated by molding. Further, the first and second molded parts are formed into a single body by fitting the fitting section into the recess section of the second molded part. Therefore, the strength and rigidity of the whole impeller can be increased in comparison with crimping, welding, or bolt fastening, which have problems of reliability in terms of strength, when stress occurs.

Since the fitting section is smaller than the central opening in the side plate, it can be easily removed from the mold and hence the first molded part can be easily molded.

Preferably, first through holes are formed in the fitting section, and second through holes are formed in said boss section. The second through holes can be aligned with said first through holes respectively, in a state where said fitting section is fitted into said recess section. In this arrangement, the first molded part and the second molded section can be attached to the rotating shaft of the drive source by bolts which are passed through the first through holes and the second through holes aligned with each other, respectively.

In addition, small projections may be formed on the free edges of any of the vanes, and small may be formed in the second molded part. The small projections can be passed when the fitting section is fitted into the recess section. In this case, the first molded part and the second molded part can be integrated into a single body by deforming portions of the small projections which project beyond the small holes.

As described above, the impeller according to the present invention is able to reduce the labor and costs involved in forming the impeller, as well as improving the reliability of the impeller in terms of strength.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the course of the following detailed description, reference will be made to the attached drawings in which:

FIG. 1 is a side elevation, partially broken away, of a pneumatic ejection type cleaning device in which an impeller according to the present invention is incorporated;

FIG. 2 is a cross-sectional view of the impeller according to the present invention;

FIG. 3 is a perspective exploded view of the impeller according to the present invention; and

FIG. 4 is a perspective exploded view of the impeller, as viewed in the opposite direction to FIG. 3.

### DETAILED DESCRIPTION OF THE PREFERRED EMBODIMENTS

Referring now to the drawing, a preferred embodiment of the present invention will be described in detail.

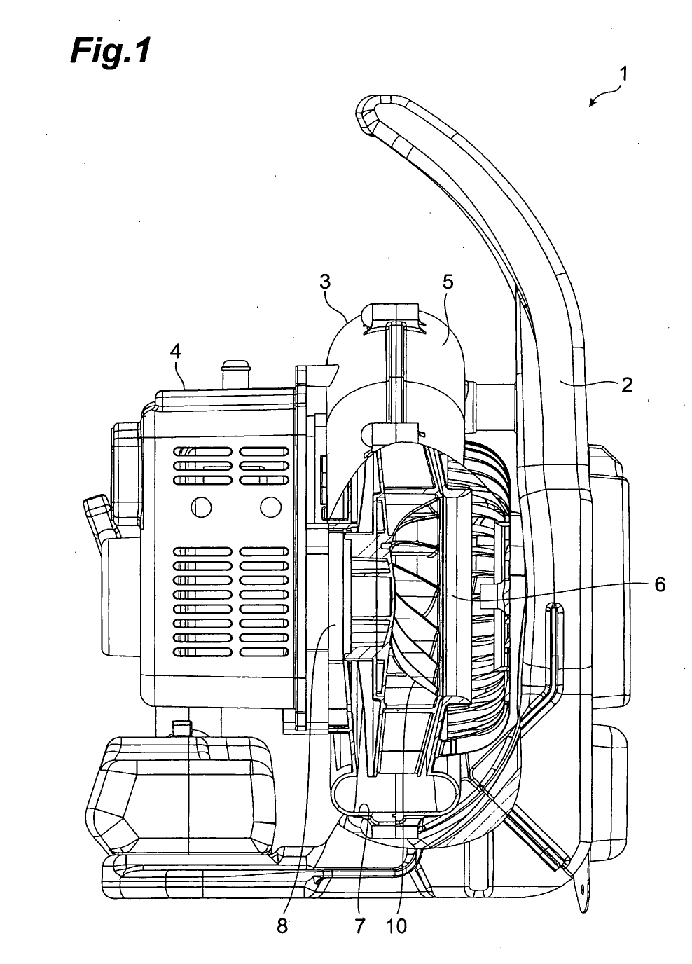

FIG. 1 is a schematic side elevational view, partially broken away, of a pneumatic ejection type knapsack cleaning device, particularly showing a centrifugal blower using an impeller according to the present invention. The cleaning device 1 shown in FIG. 1 comprises a centrifugal blower 3 mounted on a carrying frame 2 which an operator carries on his or her back, and an internal combustion engine 4 acting as a drive source for the blower. By driving the engine 4 to rotate the impeller 10 in the blower 3, air is sucked into a central opening 6 in the casing 5, and then radially-outwardly expelled from the interior of the impeller 10, passing through the outermost spiral-shaped section 7 of the casing 5, finally being ejected from a nozzle through a hose (not shown).

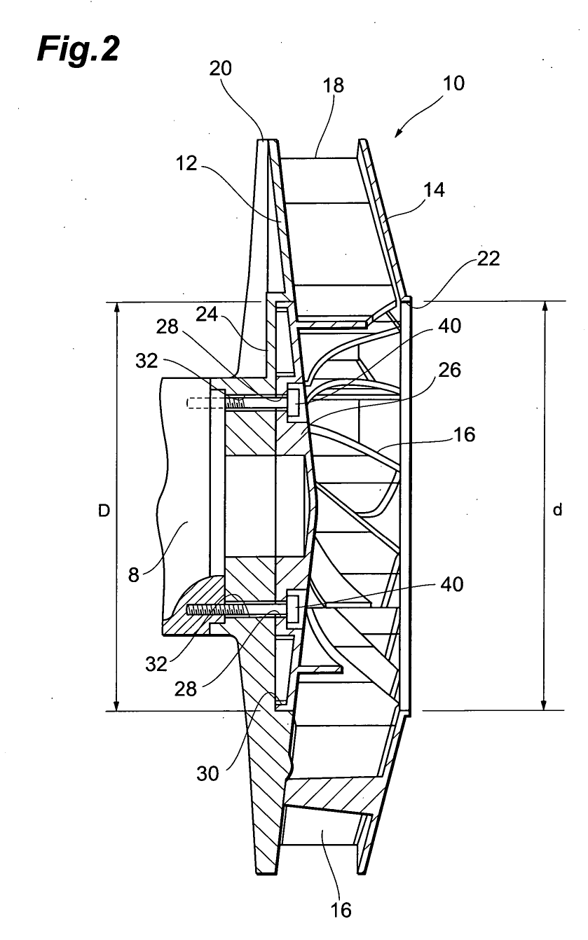

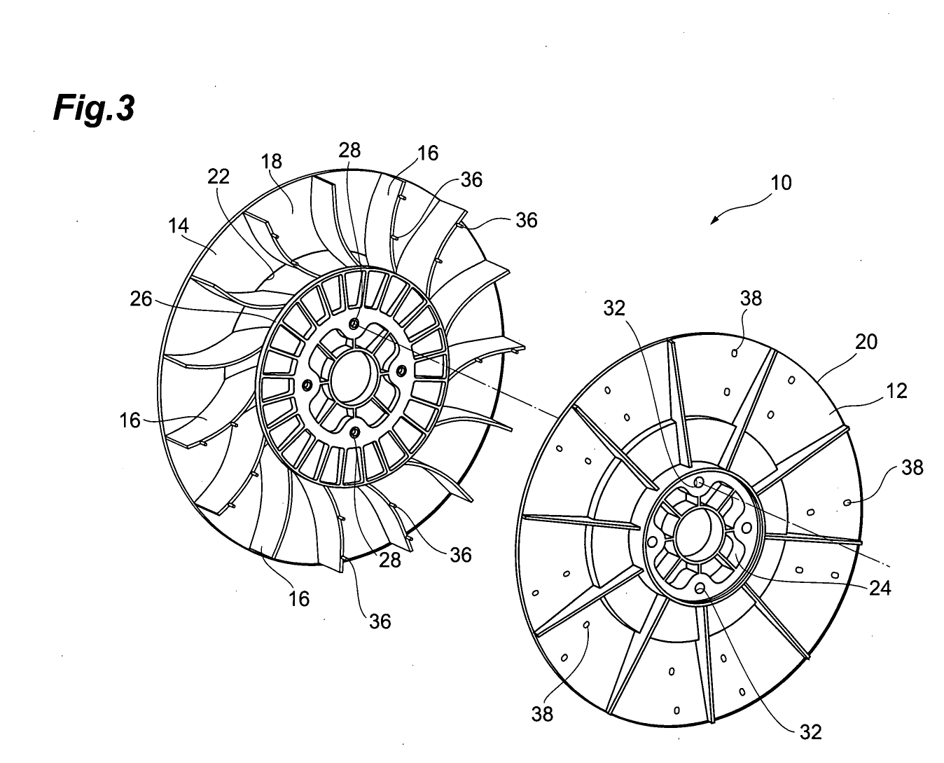

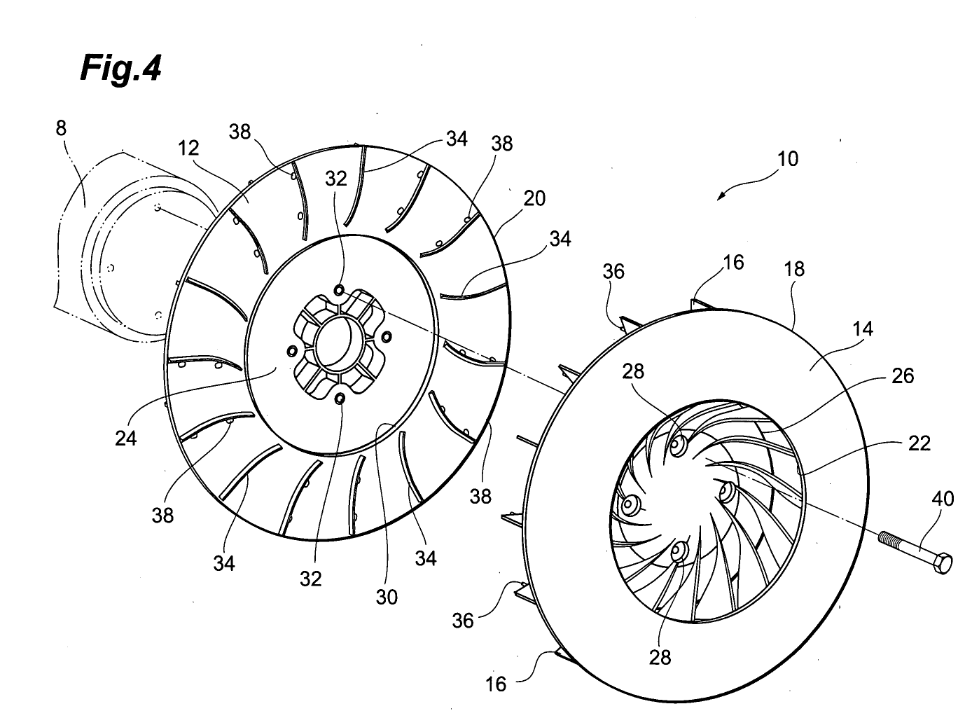

As shown in FIG. 2, the impeller 10 of the centrifugal blower 3 used in the pneumatic ejection type cleaning device 1 of the illustrated embodiment is a closed type. The impeller 10 comprises a circular disk-shaped main plate 12, a ring-shaped side plate 14, and a plurality of vanes 16 disposed between the main plate 12 and the side plate 14, these members being made of a synthetic resin. The impeller 10 is made of two molded parts 18 and 20, as shown in FIG. 3 and FIG. 4. One of the molded parts (the first molded part) 18 is an integral body, comprising the side plate 14 and the vanes 16. The other molded part (the second molded part) 20 is an integral body, comprising the main plate 12.

The first molded part 18 comprises the side plate 14, and a plurality of vanes 16 which are integrally joined to one surface of the side plate 14 (the surface facing the main plate 12) and arranged at equally spaced intervals in the circumferential direction. Each of the vanes 16 extends towards the outer side from the center of the impeller 10. The end of each vane 16 on the side of the center of the impeller 10 inwardly extends beyond the inner circumferential edge which defines the central opening 22 of the side plate 14. On the other hand, the outer end of each vane 16 terminates to the outermost edge of the side plate 14. The first molded part 18 is also provided with a small-diameter circular base or fitting section 26 which fits with a boss section 24 of the second molded part 20, described hereinafter. The circular base 26 is disposed coaxially with respect to the side plate 14, and it is integrally joined to the free edges of the vanes 16 on the side opposite to the side plate 14.

In the present embodiment, the external diameter “D” of the base 26 is smaller than the internal diameter of the side plate 14 (namely, the diameter of the central opening 22) “d”, as shown in FIG. 2. Therefore, when the first molded part 18 is integrally formed by means of injection molding or the like, it is easily removed from the mold or die, and the mold or die itself of the molding machine can be easily manufactured, thus reducing the manufacturing costs and the manufacturing labor required. Further, since the first molded part 18 is formed as an integral body, the joint portions between the side plate 14 and the vanes 16, and the joint portions between the circular base 26 and the vanes 16 can be formed with very high rigidity.

At least one first through hole (in the embodiment shown in the drawings, four holes) 28 are formed in the circular base 26. As described below, these holes 28 function as bolt holes when joining the first part 18 to the second part 20.

The second molded part 20 comprises the main plate 12. The central portion of the part 20 constitutes the boss section 24 which is adapted to couple with the rotating shaft 8 of the internal combustion engine 4. A circular recess 30 is formed in the surface of the boss section 24 opposing the first molded part 18. The diameter of the recess 30 is substantially the same as the external diameter of the circular base 26 of the first part 18 such that the circular base 26 can be fitted into the recess 30. In a state where the circular base 26 has been fitted into the recess 30, the free edges of the vanes 16 in the first part 18 make close contact with the second molded part 20, as shown in FIG. 2. Furthermore, second through holes 32 are formed in the boss section 24. The number of the holes 32 is equal to that of the through holes 28 in the circular base 26. In other words, in the present embodiment, four through holes 32 are formed. The holes 32 are arranged such that they are aligned with the corresponding through holes 32 in the circular base 26 when the base 26 is fitted into the recess 30.

As seen from FIG. 3 and FIG. 4, since the surface of second molded part 20 does not have complicated irregular profiles, it is extremely easy to form the part 20 as a single integral body.

As shown in FIG. 4, in the present embodiment, a plurality of projecting ribs 34 are integrally formed on the surface of the second molded part 20 opposing the side plate 14 of the first molded part 18. The projecting ribs 34 are provided in the same number as the vanes 16. The ribs 34 make contact with and support the free edges of the corresponding vanes 16, when the circular base 26 is fitted into the recess 30. This serves to locate the members in position, prevent rattling, and increase strength.

Furthermore, in order to simplify the position adjustment between the first and second molded parts 18 and 20 in the circumferential direction, it is preferred that short projections 36 are formed on the free edges of any of the vanes 16, and that holes 38 for receiving the short projections 36 are formed in the area of the second molded part 20 which makes contact with those free edges of the vanes 16.

The above-mentioned impeller 10 may be assembled as follows.

Firstly, the circular base 26 of the first molded part 18 is fitted into the recess 30 of the second molded part 20, and the through holes 32 in the boss section 24 are aligned with the corresponding through holes 28 in the base 26. Thereby, the first part 18 is precisely positioned to the second part 20 in the circumferential direction. In this state, in the case where the short projections 36 are formed on the vanes 16 as described above, it is possible to achieve more reliable position adjustment by inserting the short projections 36 into the corresponding holes 38 in the second part 20.

Thereafter, the first and second molded parts 18 and 20 which have been aligned in position in the above mentioned way are coupled to the rotating shaft 8 of the internal combustion engine 4, while the parts 18 and 20 remain in the assembled manner. More specifically, after the first and second molded parts 18 and 20 are assembled to each other, the end of the rotating shaft 8 of the internal combustion engine 4 mates with the boss section 24 of the second part 20, and fixing screw holes formed in the end of the rotating shaft 8 are aligned with the through holes 28 and 32 in the first and second parts 18 and 20. Then, bolts 40 are inserted into these holes and fastened. In this way, both of the first and second parts 18 and 20 are coupled to the rotating shaft 8 of the internal combustion engine 4 at one time, whereby the integrated parts 18 and 20 can function as the impeller 10.

In this case, since the circular base 26 of the first molded part 20 and the boss section 24 of the second molded part 20 are fastened together to form an integral body, high rigidity is achieved in comparison with a case where the vanes are joined to the main plate or the side plate by means of crimping, welding, fastening bolts or the like. Further, as stated previously, the side plate 14 is provided integrally with the vanes 16. Therefore, even if stress is concentrated in the joint portions between the vanes 16 and the plate 14, the structure according to the present invention is able to withstand the stress satisfactorily. In addition, as the vanes 16 are supported by the projecting ribs 34 of the second part 20, the joint portions between the vanes 16 and the main plate 12 have more strength. As a result, it is possible to provide the impeller 10 with sufficient strength in order to withstand high-speed revolution, and therefore, it is possible to improve the performance of the centrifugal blower 3, and consequently, to improve the performance of the cleaning device 1 which uses this centrifugal blower 3.

If the holes 38 formed in the second molded part 20 are small holes that pass through the second molded part 20 and the ends of the small projections 36 on the vanes 16 project beyond the small holes 38, after assembling the first and second parts 18 and 20 together, the exposed ends of the short projections may be melted and deformed, thereby forming the first molded part 18 and the second mold section 20 into a body As the result, the task of attaching the impeller 10 to the rotating shaft 8 of the internal combustion engine 4 can be simplified.

It is thought that the present invention and many of its attendant advantages will be understood from the foregoing description and it will be apparent that various changes may be made in the form, construction and arrangement thereof without departing from the spirit and scope of the invention or sacrificing all of its material advantages, the form hereinbefore described being merely a preferred or exemplary embodiment thereof.

For example, the impeller in the aforementioned embodiment is made of a synthetic resin, but it may be molded of metal (i.e. casting).

Also, although the recess 30 of the second molded part 20 and the fitting section 26 of the first molded part 18 fitting into this recess 30 are in circular shape in the illustrated embodiment, they may have another shape. Even if the fitting section 26 has another shape, as long as the area of the section 26 is smaller than that of the central opening 22 of the side plate, it is possible to release the member 18 from the mold easily, in a similar fashion to the case described above.

In the aforementioned embodiment, both of the first and second molded parts 18 and 20 are fastened to the rotating shaft 8 of the internal combustion engine 4. However, a method may be conceived in which the circular base 26 of the first part 18 and the boss section 24 of the second part 20 are joined by nut and bolt fastenings, whereupon only the second part 20 is fixed to the rotating shaft 8.

Furthermore, a person skilled in the art will readily appreciate that the shapes of the vanes 16, side plate 14 or the like of the impeller 10, the type of the centrifugal blower 3 to which the impeller 10 is applied, the apparatus in which the centrifugal blower 3 is used, and other features, are not limited to those described above.

What is claimed is:

1. An impeller (10) for a centrifugal blower (3) including a main plate (12) adapted to be attached to a rotating shaft (8) of a drive source (4), a side plate (14) disposed coaxially at a predetermined interval with respect to said main plate (12), said side plate (12) having a central opening (22) formed therein, and a plurality of vanes (16) disposed at equally spaced intervals in the circumferential direction between said main plate (12) and said side plate (14), said impeller (10) comprising:
a first molded part (18) including said side plate (14), said vanes (16) and a fitting section (26), and molded into a single-piece, said fitting section (26) having a smaller area than said central opening (22) of said side plate (14) and provided on the free edges of said vanes (16) on the side opposite to said side plate (14) in a coaxial relation to said side plate (14); and
a second molded part (20) molded into a single-piece, said second molded part (20) constituting said main plate (12) and having a boss section (24) provided in the center thereof, said boss section (24) being adapted to couple with the rotating shaft (8) of the drive source (4) and having a recess section (30) formed therein into which said fitting section (26) is fitted;
wherein said first molded part (18) and said second molded part (20) are integrated into a single body by fastening said fitting section (26) to said boss section (24) in a state where said fitting section (26) is fitted into said recess section (30).

2. An impeller for a centrifugal blower according to claim 1, wherein first through holes (28) are formed in the fitting section (26);
second through holes (32) are formed in said boss section (24), said second through holes (32) aligned with said first through holes (28) respectively, in a state where said fitting section (26) is fitted into said recess section (30); and
said first molded part (18) and said second molded section (20) are adapted to be attached to the rotating shaft (8) of the drive source (4) by bolts (40) which are passed through said first through holes (28) and said second through holes (32) aligned with each other, respectively.

3. An impeller for a centrifugal blower according to claim 1, wherein small projections (36) are formed on the free edges of any of said vanes (16);
said second molded part (20) has small holes (38) formed therein through which said small projections (36) are passed when said fitting section (26) is fitted into said recess section (30); and
said first molded part (18) and said second molded part (20) are integrated into a single body by deforming portions of said small projections (36) which project beyond said small holes (38).
